(19) United States
(12) Patent Application Publication
(10) Pub. No.: US 2004/0000216 A1
(43) Pub. Date: Jan. 1, 2004

(54) Connecting rod for internal combustion engine

(76) Inventors: Kevin G. Bonde, Kiel, WI (US); Yun Huang, Sheboygan, WI (US); John A. Psihoyios, Sheboygan, WI (US)

Correspondence Address: QUARLES & BRADY LLP, 411 E. WISCONSIN AVENUE, SUITE 2040, MILWAUKEE, WI, 53202-4497, US

(21) Appl. No.: 10/187,130

(22) Filed: Jun. 28, 2002

(51) Int. Cl. G05G 1/00

(52) U.S. Cl. 74/579 R

(57) ABSTRACT

Connecting rods are disclosed. One of the connecting rods has a shank, a cap, and means for fastening the cap and shank. The shank includes a piston pin end defining a piston pin bearing, two rod components fixedly coupled to the piston pin end, and a crank pin end portion fixedly coupled to the rod components and defining a first crank pin bearing segment. The rod components are spaced apart so that an aperture is defined between the rod components. The cap forms a second crank pin end portion and defines a second crank pin bearing segment. Another connecting rod has two halves that, when assembled, include a piston pin end with a piston pin bearing, a crank pin end with a crank pin bearing, and two rods that couple the two ends and define an interior aperture.

### FIELD OF THE INVENTION

The present invention relates to internal combustion engines. In particular, the present invention relates to connecting rods that are employed within internal combustion engines to couple the pistons of those engines with the crankshafts of the engines.

### BACKGROUND OF THE INVENTION

Internal combustion engines employ connecting rods to connect one or more pistons within corresponding cylinders of the engines with the engines' crankshafts. Typically, a connecting rod is a shaft that has bearings at each of its ends. One of the bearings is for coupling the connecting rod to a piston pin within a piston, while the other of the bearings is for coupling the connecting rod to a crank pin of the crankshaft.

Connecting rods experience severe forces when operating within engines. In particular, severe compression forces are placed upon a connecting rod when combustion occurs within an engine cylinder and causes the piston and connecting rod to move toward the crankshaft.

Many conventional connecting rods employ a single solid segment of material in between the respective piston and crank pin ends at which are positioned the piston and crank pin bearings. Such connecting rods are particularly susceptible to fatigue because high stresses are imposed between the piston and crank pin bearings near the piston pin bearing, in-line with the load from bearing to bearing.

Another design for a connecting rod is disclosed in U.S. Pat. No. 4,836,045, which issued on Jun. 6, 1989 to Arnold Löbig. In that patent, the connecting rod includes two separate halves, which are complementary. Each half is configured to include a respective complete piston pin bearing portion (defining 360 degrees of the piston pin bearing), a respective partial crank pin bearing portion that defines 180 degrees of the crank pin bearing, and a respective rod component coupling its respective complete piston pin bearing portion and partial crank pin bearing portion.

When the halves are assembled into the connecting rod, the pair of piston pin bearing portions are positioned one in front of the other so as to form a single overall piston pin bearing. The rod components are arranged on opposite sides of a longitudinal plane defined by the piston and crank pin bearing axes, and are separated from one another by a central aperture. Additionally, the two partial crank pin bearing portions complement one another to form the overall crank pin bearing.

The connecting rod of the Lobig patent is designed to provide a certain advantage—namely, the design allows both halves of the connecting rod to be positioned onto the piston pin of the piston without, at the same time, requiring the connecting rod to be attached to the crank pin. Because each half has its own complete piston pin bearing portion, and because each of the crank pin bearing portions only defines half the circumference of the crank pin bearing, the halves of the connecting rod can be rotated apart from one another on the piston pin such that, at a later time, the partial crank pin bearing portions can be assembled around the crank pin.

Despite this advantage of the connecting rod of the Lobig patent, the connecting rod nevertheless has certain disadvantages. In particular, because the connecting rod includes two separate piston pin bearing portions and rod components, the connecting rod continues to experience fatigue as a result of the stresses that are imposed near the piston pin bearing. Because of the particular design of this connecting rod, with its separate rods and axially-stacked piston pin bearing portions, the fatigue experienced by the connecting rod is different than that which is experienced by a more standard connecting rod having a single solid segment between the piston and crank pin bearings. Nevertheless, the fatigue is still significant.

Another disadvantage of the connecting rod of the Lobig patent is that, even though the two halves of the connecting rod are identical and complementary, the manufacturing of the halves is relatively complicated and costly. In particular this is true because, in addition to forming the halves with their individual crank pin bearing portions, rod components, and additional extensions for the piston pin bearing portions, one must also drill or otherwise form the actual piston pin bearings (e.g., holes) within those extensions to form the piston pin bearing portions.

It would therefore be advantageous if a new connecting rod could be designed that was better able to tolerate the significant compression stresses imposed upon the connecting rod during combustion within an engine than conventional connecting rods. In particular, it would be advantageous if the stresses occurring just below the piston pin bearing in between the piston pin bearing the crank pin bearing could be better tolerated or resisted. Further, it would be advantageous if a new connecting rod could be designed that was simpler and less costly to manufacture than existing connecting rods.

### SUMMARY OF THE INVENTION

The present inventors have discovered a first connecting rod design in which the connecting rod includes a shank having two rod components that couple a piston pin end defining a piston pin bearing and a first portion of a crank pin end defining a first portion of a crank pin bearing. The two rod components are positioned on opposite sides of an inner aperture. Because the rod components are both attached to the same piston pin end and portion of the crank pin end, and because of the aperture positioned in between the piston pin end and the crank pin end, the connecting rod is capable of tolerating great stresses, particularly proximate the piston pin bearing. To complete the crank pin end and fully define the crank pin bearing, the connecting rod additionally includes a cap that forms a second portion of the crank pin end. The cap is capable of being coupled to, and removed from, the first portion of the crank pin end.

In one embodiment of the first connecting rod design, the cap is aligned with the shank by a pair of cylindrical sleeves. The cylindrical sleeves fit within complementary holes in the cap and also extend into complementary recesses that extend part of the way into the first portion of the crank pin end. Bolts inserted into the cap fit through and then extend past the cylindrical sleeves and complementary recesses into additional holes within the first portion of the crank pin end, such that the bolts are coupled to the first portion of the crank pin end and thereby hold the cap to the shank.

The present inventors have further discovered a second connecting rod design that allows for very simple and cost-effective manufacturing of the connecting rod. In this embodiment, the connecting rod is formed from two identical or nearly-identical halves, each of which includes a respective rod component that is coupled between a respective portion of the piston pin end and a respective portion of the crank pin end. The respective portions of the piston pin and crank pin ends of the different halves are complementary and, in one embodiment, each portion of an end defines half of a respective bearing. When the two halves of the connecting rod are assembled, the rod components of the connecting rod are positioned on opposite sides of an inner aperture.

Because the halves of the second connecting rod design are identical or nearly-identical, the connecting rod can be manufactured simply and cost-effectively by making only a single part, namely, the halves. While in certain embodiments the bearings within the connecting rod are created by drilling the bearings after assembling the halves of the connecting rod, it is further envisioned that in other embodiments the halves of the connecting rod will be manufactured to include the bearing portions without the need for any drilling operation. Because each connecting rod portion only includes halves of any given bearing as opposed to a full bearing, it is possible to form the halves of the connecting rod to include the bearing portions without the formation of welding points (or “knit-lines”). Also, in one embodiment of the second connecting rod design, cylindrical sleeves are again employed to align the halves of the connecting rod when assembled. The cylindrical sleeves are positioned in complementary holes and recesses located between the inner aperture and the respective piston pin and crank pin bearings, and bolts that extend beyond the cylindrical sleeves are again employed to fasten the two halves together. Each of the inventive connecting rod embodiments allows for low-cost molding processes, low-cost tooling, and/or low-cost machining to be used in creating the connecting rods.

In particular, the present invention relates to a connecting rod that includes a shank, a cap and means for fastening the cap to the shank. The shank includes a piston pin end that defines a complete piston pin bearing. The shank also includes first and second rod components that are fixedly coupled to the piston pin end, and a first portion of a crank pin end that is fixedly coupled to the first and second rod components and defines a first segment of a crank pin bearing. The first and second rod components are spaced apart from one another so that a first aperture is defined between the rod components and between the piston pin bearing and the first segment of the crank pin bearing. The cap forms a second portion of the crank pin end and defines a second segment of the crank pin bearing. The cap is capable of being removed from and attached to the shank.

The present invention further relates to a connecting rod that includes a first side component. The first side component in turn includes a first portion of a piston pin end defining a first segment of a piston pin bearing, a first portion of a crank pin end defining a first segment of a crank pin bearing, and a first rod component fixedly coupled between the first portions of the piston pin end and crank pin end. The first side component is configured to be assembled together with a second side component having a second rod component. The first side component is configured so that upon assembly with the second side component, a first aperture is formed between the first and second rod components.

The present invention additionally relates to a method of assembling a connecting rod. The method includes providing a first part of the connecting rod, where the first part includes first and second holes. The method further includes providing a second part of the connecting rod, where the second part includes third and fourth holes, and where the holes are positioned so that, upon assembling the first part with the second part, the first hole is aligned with the third hole and the second hole is aligned with the fourth hole. The method additionally includes inserting first and second cylindrical sleeves into one of the first and third holes and one of the second and fourth holes, respectively. The method further includes putting together the first and second parts of the connecting rod so that the first cylindrical sleeve extends into both the first and third holes and the second cylindrical sleeve extends into both the second and fourth holes, where the first and second cylindrical sleeves align the first and second parts. The method additionally includes fastening the first and second parts together by way of first and second bolts that extend through the first and second cylindrical sleeves, respectively.

### BRIEF DESCRIPTION OF THE DRAWINGS

FIG. 1 is a first perspective view of a single cylinder engine, taken from a side of the engine on which are located a starter and cylinder head;

FIG. 2 is a second perspective view of the single cylinder engine of FIG. 1, taken from a side of the engine on which are located an air cleaner and oil filter;

FIG. 3 is a third perspective view of the single cylinder engine of FIG. 1, in which certain parts of the engine have been removed to reveal additional internal parts of the engine;

FIG. 4 is a fourth perspective view of the single cylinder engine of FIG. 1, in which certain parts of the engine have been removed to reveal additional internal parts of the engine;

FIG. 5 is fifth perspective view of portions of the single cylinder engine of FIG. 1, in which a top of the crankcase has been removed to reveal an interior of the crankcase;

FIG. 6 is a sixth perspective view of portions of the single cylinder engine of FIG. 1, in which the top of the crankcase is shown exploded from the bottom of the crankcase;

FIG. 7 is a top view of the single cylinder engine of FIG. 1, showing internal components of the engine in grayscale;

FIG. 8 is a perspective view of components of a valve train of the single cylinder engine of FIG. 1;

FIG. 9 is an elevation view of a first connecting rod that can be employed in the engine of FIGS. 1-8, where the connecting rod includes dual rails and is shown in assembled form; and

FIG. 10 is an elevation view of a second connecting rod that can be employed in the engine of FIGS. 1-8, where the connecting rod includes dual rails and is shown in disassembled form.

### DETAILED DESCRIPTION OF THE PREFERRED EMBODIMENT

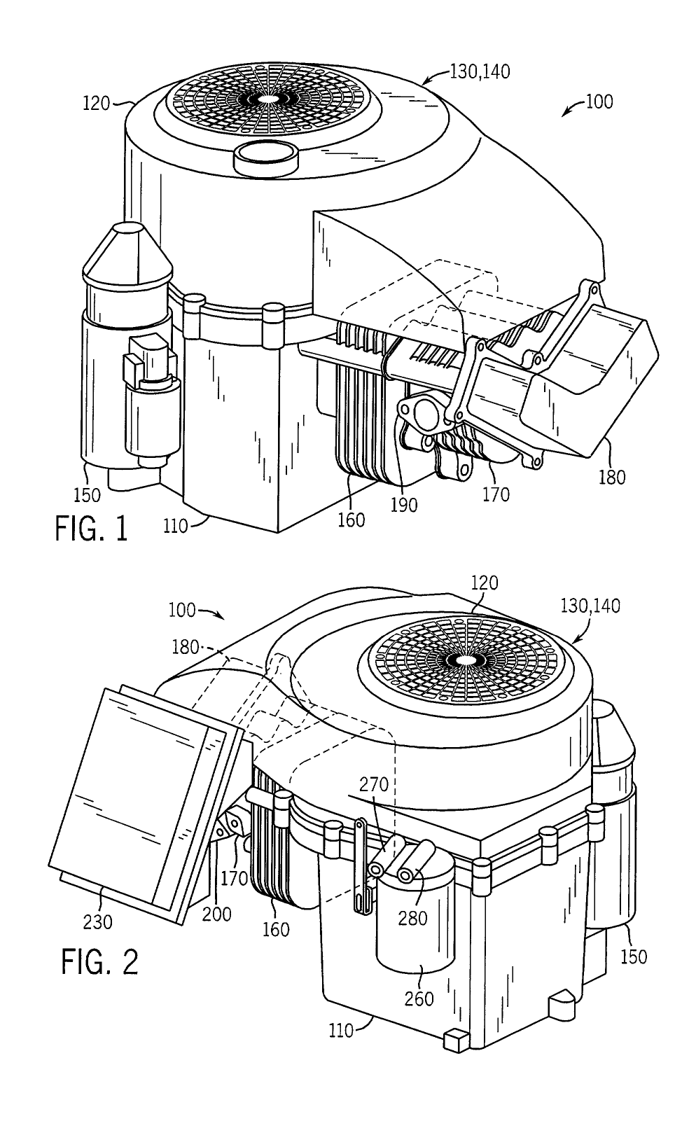

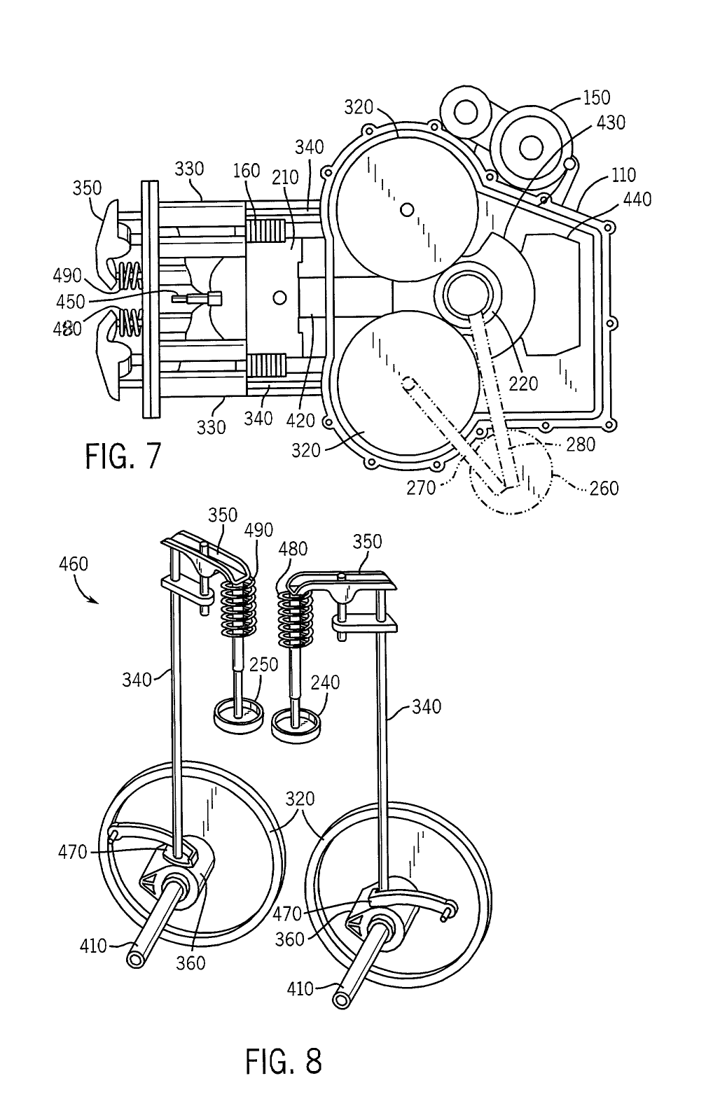

Referring to FIGS. 1 and 2, a new single cylinder, 4-stroke, internal combustion engine 100 designed by Kohler Co. of Kohler, Wis. includes a crankcase 110 and a blower housing 120, inside of which are a fan 130 and a flywheel 140. The engine 100 further includes a starter 150, a cylinder 160, a cylinder head 170, and a rocker arm cover 180. Attached to the cylinder head 170 are an air exhaust port 190 shown in FIG. 1 and an air intake port 200 shown in FIG. 2. As is well known in the art, during operation of the engine 100, a piston 210 (see FIG. 7) moves back and forth within the cylinder 160 towards and away from the cylinder head 170. The movement of the piston 210 in turn causes rotation of a crankshaft 220 (see FIG. 7), as well as rotation of the fan 130 and the flywheel 140, which are coupled to the crankshaft. The rotation of the fan 130 cools the engine, and the rotation of the flywheel 140, causes a relatively constant rotational momentum to be maintained.

Referring specifically to FIG. 2, the engine 100 further includes an air filter 230 coupled to the air intake port 200, which filters the air required by the engine prior to the providing of the air to the cylinder head 170. The air provided to the air intake port 200 is communicated into the cylinder 160 by way of the cylinder head 170, and exits the engine by flowing from the cylinder through the cylinder head and then out of the air exhaust port 190. The inflow and outflow of air into and out of the cylinder 160 by way of the cylinder head 170 is governed by an input valve 240 and an output valve 250, respectively (see FIG. 8). Also as shown in FIG. 2, the engine 100 includes an oil filter 260 through which the oil of the engine 100 is passed and filtered. Specifically, the oil filter 260 is coupled to the crankcase 110 by way of incoming and outgoing lines 270, 280, respectively, whereby pressurized oil is provided into the oil filter and then is returned from the oil filter to the crankcase.

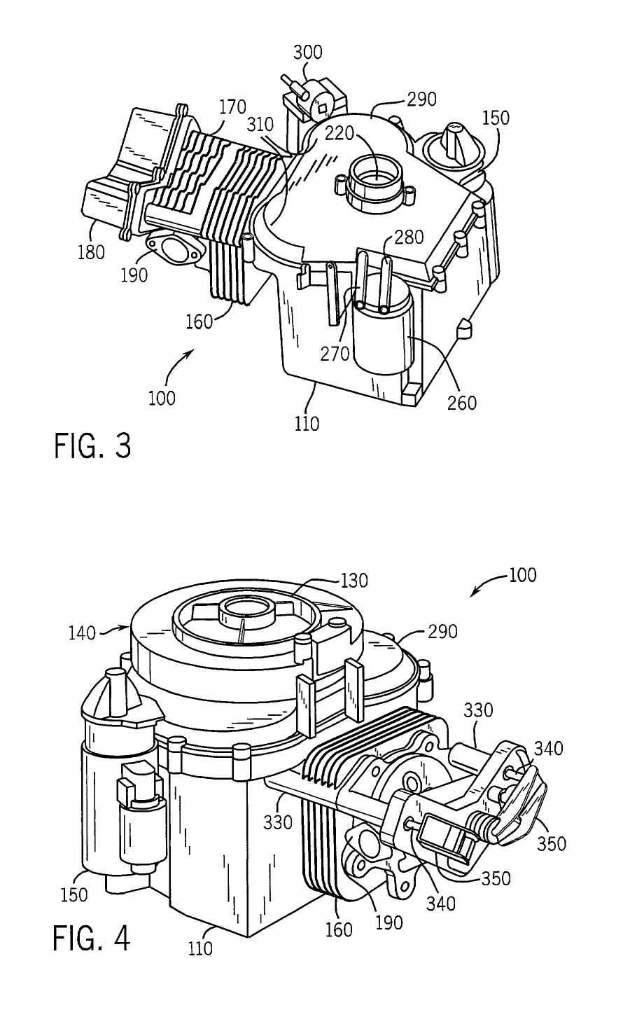

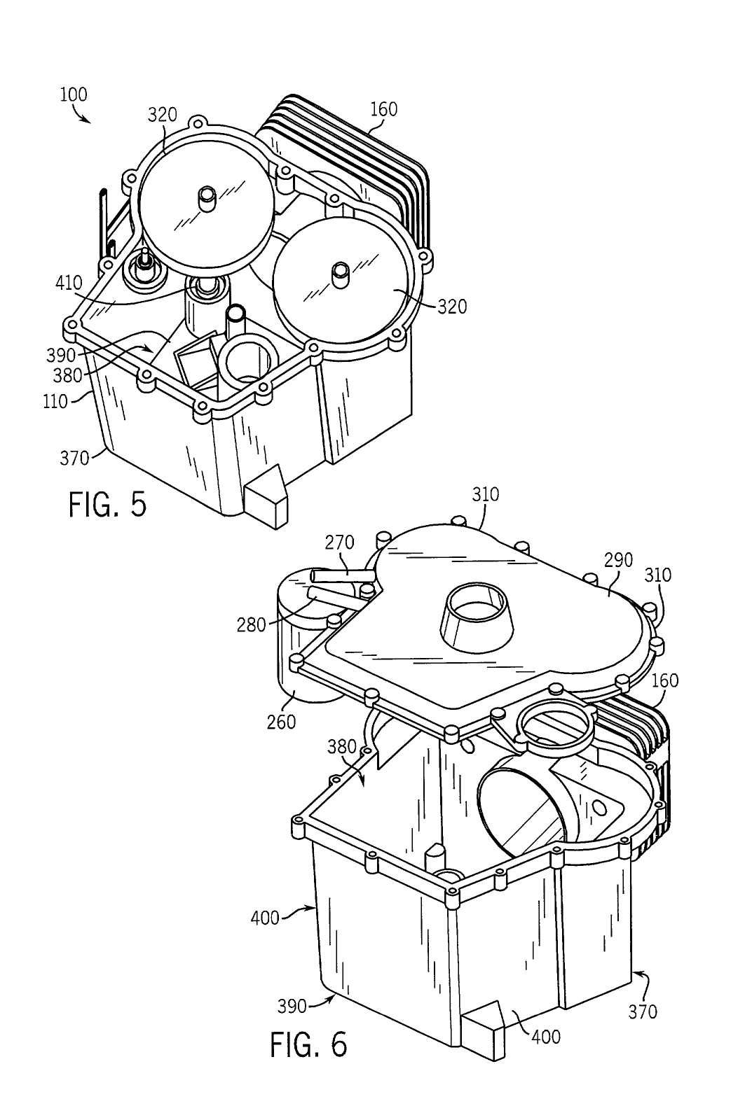

Referring to FIGS. 3 and 4, the engine 100 is shown with the blower housing 120 removed to expose a top 290 of the crankcase 110. With respect to FIG. 3, in which both the fan 130 and the flywheel 140 are also removed, a coil 300 is shown that generates an electric current based upon rotation of the fan 130 and/or the flywheel 140, which together operate as a magneto. Additionally, the top 290 of the crankcase 110 is shown to have a pair of lobes 310 that cover a pair of gears 320 (see FIGS. 5 and 7-8). With respect to FIG. 4, the fan 130 and the flywheel 140 are shown above the top 290 of the crankcase 110. Additionally, FIG. 4 shows the engine 100 without the cylinder head 170 and without the rocker arm cover 180, to more clearly reveal a pair of tubes 330 through which extend a pair of respective push rods 340. The push rods 340 extend between a pair of respective rocker arms 350 and a pair of cams 360 (see FIG. 8) within the crankcase 110, as discussed further below.

Turning to FIGS. 5 and 6, the engine 100 is shown with the top 290 of the crankcase 110 removed from a bottom 370 of the crankcase 110 to reveal an interior 380 of the crankcase. Additionally in FIGS. 5 and 6, the engine 100 is shown in cut-away to exclude portions of the engine that extend beyond the cylinder 160 such as the cylinder head 170. With respect to FIG. 6, the top 290 of the crankcase 110 is shown above the bottom 370 of the crankcase in an exploded view. In this embodiment, the bottom 370 includes not only a floor 390 of the crankcase, but also all six side walls 400 of the crankcase, while the top 290 only acts as the roof of the crankcase. The top 290 and bottom 370 are manufactured as two separate pieces such that, in order to open the crankcase 110, one physically removes the top from the bottom. Also, as shown in FIG. 5, the pair of gears 320 within the crankcase 110 are supported by and rotate upon respective shafts 410, which in turn are supported by the bottom 370 of the crankcase 110.

Referring to FIG. 7, a top view of the engine 100 is provided in which additional internal components of the engine are shown in grayscale. In particular, FIG. 7 shows the piston 210 within the cylinder 160 to be coupled to the crankshaft 220 by a connecting rod 420. The crankshaft 220 is in turn coupled to a rotating counterweight 430 and reciprocal weights 440, which balance the forces exerted upon the crankshaft 220 by the piston 210. The crankshaft 220 further is in contact with each of the gears 320, and thus communicates rotational motion to the gears. In the present embodiment, the shafts 410 upon which the gears 320 are supported are capable of communicating oil from the floor 390 of the crankcase 110 (see FIG. 5) upward to the gears 320. The incoming line 270 to the oil filter 260 is coupled to one of the shafts 410 to receive oil, while the outgoing line 280 from the oil filter is coupled to the crankshaft 220 to provide lubrication thereto. FIG. 7 further shows a spark plug 450 located on the cylinder head 170, which provides sparks during power strokes of the engine to cause combustion to occur within the cylinder 160. The electrical energy for the spark plug 450 is provided by the coil 300 (see FIG. 3).

Further referring to FIG. 7, and additionally to FIG. 8, elements of a valve train 460 of the engine 100 are shown. The valve train 460 includes the gears 320 resting upon the shafts 410 and also includes the cams 360 underneath the gears, respectively. Additionally, respective cam follower arms 470 that are rotatably mounted to the crankcase 110 extend to rest upon the respective cams 360. The respective push rods 340 in turn rest upon the respective cam follower arms 470. As the cams 360 rotate, the push rods 340 are temporarily forced outward away from the crankcase 110 by the cam follower arms 470. This causes the rocker arms 350 to rock or rotate, and consequently causes the respective valves 240 and 250 to open toward the crankcase 110. As the cams 360 continue to rotate, however, the push rods 340 are allowed by the cam follower arms 470 to return inward to their original positions. A pair of springs 480,490 positioned between the cylinder head 170 and the rocker arms 350 provide force tending to rock the rocker arms in directions tending to close the valves 240,250, respectively. Further as a result of this forcing action of the springs 480,490 upon the rocker arms 350, the push rods 340 are forced back to their original positions.

In the present embodiment, the engine 100 is a vertical shaft engine capable of outputting 15-20 horsepower for implementation in a variety of consumer lawn and garden machinery such as lawn mowers. In alternate embodiments, the engine 100 can also be implemented as a horizontal shaft engine, be designed to output greater or lesser amounts of power, and/or be implemented in a variety of other types of machines, e.g., snow-blowers. Further, in alternate embodiments, the particular arrangement of parts within the engine 100 can vary from those shown and discussed above. For example, in one alternate embodiment, the cams 360 could be located above the gears 320 rather than underneath the gears.

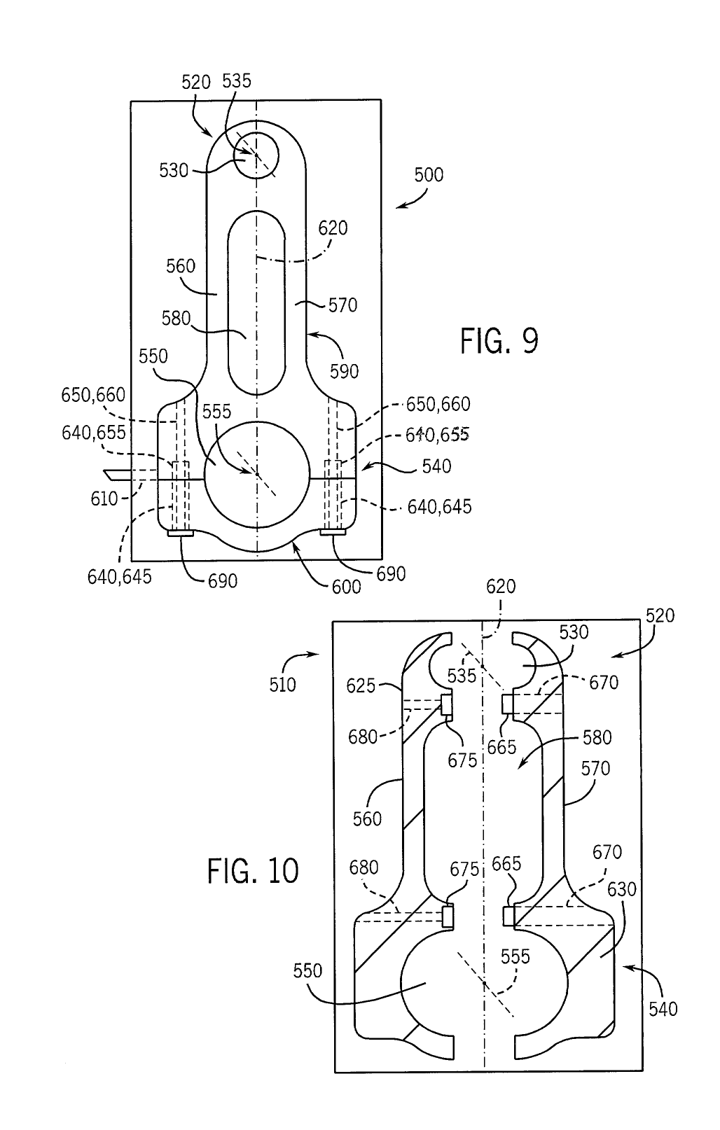

FIGS. 9 and 10 respectively show first and second connecting rods 500,510 that can be employed in the engine 100 described with respect to FIGS. 1-8 (as the connecting rod 420 shown in FIG. 7). Each of the connecting rods 500,510 has a piston pin end 520 with a piston pin bearing 530 at which the respective connecting rod is designed to receive a piston pin (not shown) of the piston 210, and also a crank pin end 540 with a crank pin bearing 550 at which the respective connecting rod is designed to receive the crank pin (not shown) on the crankshaft 220. The respective piston pin end 520 and crank pin end 540 of each of the connecting rods 500,510 are connected by way of respective first and second rod components or rails 560,570 that are on opposite sides of a respective interior aperture of cavity 580. The respective interior cavity 580, particularly with respect to the first connecting rod 500, allows greater stresses to be tolerated by the connecting rod, particularly near the respective piston pin end 520. This is because the existence of the cavity 580 decreases the stiffness of the connecting rod directly beneath the bearings 530,550 (e.g. between the bearings and the interior cavity 580) so as to distribute load and stresses more uniformly in the two rails 560,570.

As shown, the embodiments of FIGS. 9 and 10 are similarly sized, and have similar geometries that each include the dual rails 560,570 and the interior cavity 580. The primary differences between the respective connecting rods 500,510 of FIGS. 9 and 10 concern their component parts. The first connecting rod 500 of FIG. 9 has a shank 590 that includes the piston end 520, both of the rails 560,570, and a portion of the crank pin end 540 that defines a portion or segment of the crank pin bearing 550. In addition, the first connecting rod 500 has a cap 600 that completes the crank pin end 540 and defines the remainder of the crank pin bearing 550.

In the present embodiment, the cap 600 interfaces, and is separable from, the shank 590 along a first plane 610 that extends through an axis 555 of the cranks pin bearing 550 and is perpendicular to a middle axis 620 of the connecting rod 500 that extends lengthwise through the connecting rod. The middle axis 620 in particular extends perpendicularly through the axis 555 of the crank pin bearing 550 and an axis 535 of the piston pin bearing 530. The cap 600 extends around and defines 180 degrees of the crank pin bearing 550, while the shank extends around and defines the remaining 180 degrees of the crank pin bearing.

In alternate embodiments, the cap 600 can interface the shank 590 in a different manner than that shown. For example, in one alternate embodiment, the cap would extend around approximately 210 degrees of the crank pin bearing 550 while the shank would extend around the remaining 150 degrees of the crank pin bearing. Also, in alternate embodiments, the cap 600 need not interface the shank 590 along a plane, or along a plane that is perpendicular to the middle axis 620 of the connecting rod or that extends through the axis 555.

In contrast to the first connecting rod 500, the second connecting rod 510 has first and second side components or halves 625,630, each of which has the same overall outer geometry and includes a respective one of the first and second rails 560,570. The side components 625,630 interface, and are separable from, one another along the plane defined by the middle axis 620 and either of the axes 535,555. Consequently, each of the side components 625,630 extends around, and defines, 180 degrees of each of the piston pin bearing 530 and the crank pin bearing 550.

In alternate embodiments, the side components 625,630 need not have exactly the same outer geometry (or strictly constitute halves of the connecting rod), but rather can have complementary geometries such that the side components can be assembled together. Also, in alternate embodiments, the side components 625,630 need not interface one another along the plane defined by the middle axis 620 and either of the axes 535,555. For example, in one alternate embodiment, the side components 625,630 interface one another proximate the piston pin bearing 530 along a first plane parallel to the axis 535 of the piston pin bearing, while the side components interface one another proximate the crank pin bearing 550 along a second plane parallel to the axis 555 of that bearing, where the first and second planes are different planes.

As shown in FIG. 9, the cap 600 and shank 590 of the first connecting rod 500 are assembled to one another by way of a pair of bolts 650. The cap 600 and shank 590 further are aligned with one another by cylindrical sleeves 640. The cylindrical sleeves 640 fit within complementary holes 645 in the cap on either side of the crank pin bearing 550. When fully positioned within the holes 645, the cylindrical sleeves 640 extend beyond the first plane 610. Upon assembly of the cap 600 with the shank 590, the cylindrical sleeves 640 further extend into complementary holes or recesses 655 in the shank, which extend partially into the shank 590, such that the cylindrical sleeves 640 align the cap 600 with the shank 590.

The bolts 650 are positioned within the respective cylindrical sleeves 640 and extend beyond the sleeves and the recesses 655 further into additional holes 660 in the shank 590. Each of the bolts 650 has a respective head 690 with a diameter greater than that of its respective cylindrical sleeve 640. Each of the additional holes 660 typically will have threads to mate with complementary threads on the bolts 650 although, in alternate embodiments, nuts could be fastened to the ends of the bolts. By tightening the bolts into the additional holes 660 (or with respect to complementary nuts) so that the heads 690 abut the cap 600, the cap is fastened to the shank 590.

FIG. 10 further shows that the first and second side components 625,630 can also be aligned by way of cylindrical sleeves 665 and assembled by way of bolts (not shown). In the embodiment shown, the cylindrical sleeves 665 are fit within holes 670 in the second side component 630 between the interior cavity 580 and each of the piston and crank pin bearings 530 and 550, respectively. As with the embodiment of FIG. 9, the cylindrical sleeves 665 extend beyond the second side component 630 when fitted therein so that, when the first side component 625 and the second side component are assembled, the cylindrical sleeves extend into complementary holes or recesses 675 in the first side component. The bolts (not shown) extend from the cylindrical sleeves 665 into additional holes 680 to fasten the first and second side components 625,635 together. In alternate embodiments, the cylindrical sleeves 665 can be fitted into holes located at different or additional positions along the first and second side components, for example, at the opposite ends of the connecting rod 510 beyond the piston and crank pin bearings 530,550.

In alternate embodiments, the cap 600 and shank 590 of FIG. 9 and the first and second side components 625,630 of FIG. 10 can be assembled and aligned by way of any of a number of other methods and fastening devices. For example, the cap and the shank could be aligned by providing one or more notches in one of the two parts and one or more complementary teeth in the other of the two parts, such that each tooth would fit into a complementary notch upon assembly of the connecting rod and thereby align the cap with the shank. Also, for example, the cap and the shank could be fastened to one another by way of a single bolt on one side of the crank pin bearing 550, where the cap and the shank were fastened to one another on the other side of the crank pin bearing by way of a hooking device.

The first and second connecting rods 500,510, and their respective components, can be manufactured by any of a number of processes and from any of a number of materials. In one embodiment, the connecting rods are manufactured in an assembled form by way of extrusion or powdered-metal (PM) technologies using a standard 6061-T6 alloy. Upon being formed, the connecting rods are split or broken into their component parts, e.g., the cap 600 is broken off from the shank 590. In another embodiment, particularly with respect to the connecting rod 510 of FIG. 10, the identical (or nearly-identical) side components 625,635 can be manufactured individually rather than in the assembled form.

In certain embodiments, the crank pin and piston pin bearings 550,530 of the connecting rods 500,510 are produced by drilling the bearings after assembling, as applicable, the cap 600 and shank 590 or the side components 625,630 to one another. However, it is further envisioned that in other embodiments the bearings will be manufactured as part of the process of manufacturing the cap 600 and shank 590 or side components 625,630 themselves, e.g., by way of extrusion or PM technologies. Such manufacture of the bearings could further simplify and reduce the costs associated with manufacturing the connecting rods. Manufacture of the bearings in this way would be particularly appropriate in the case of the connecting rod 510, since each of the side components 625,630 of that connecting rod only includes half-bearings, which can be manufactured by way of extrusion or PM technologies without the creation of welding points (or “knit-lines”) as typically occur when using such technologies to manufacture entire bearings (e.g., where all 360 degrees of a given bearing are being formed within a single connecting rod component).

In certain embodiments, the side components 625,630 of the connecting rod 510 are designed to clamp around and onto the piston pin. Because the side components clamp onto the piston pin, the piston pin no longer can experience relative movement with respect to the connecting rod. Consequently, such clamping eliminates the need for pin retainer clips within the piston, which otherwise commonly are employed at one or both ends of the piston pin to prevent relative sliding of the piston pin with respect to the connecting rod. Further, when the connecting rod is intended to clamp onto the piston pin, it is not necessary to machine or otherwise form the piston pin bearing 530 with as much accuracy as in the case where it is desired that the piston pin freely rotate with respect to the connecting rod. It is further possible, in certain embodiments, for the side components 625,630 of the connecting rod 510 to be designed to clamp onto the crank pin, or for the cap 600 and shank 590 of the connecting rod 500 to be designed to clamp onto the crank pin.

Where holes or recesses such as the complementary holes 645, recesses 655 and additional holes 660 are employed in the connecting rods, these holes or recesses can be drilled or otherwise formed within the connecting rod components. In embodiments of the connecting rods 500,510 in which the connecting rods are manufactured as single pieces and then divided into their component parts, the holes and recesses can be drilled prior to the dividing of the connecting rods into their components parts.

While the foregoing specification illustrates and describes the preferred embodiments of this invention, it is to be understood that the invention is not limited to the precise construction herein disclosed. The invention can be embodied in other specific forms without departing from the spirit or essential attributes of the invention. Accordingly, reference should be made to the following claims, rather than to the foregoing specification, as indicating the scope of the invention.

What is claimed is:

1. A connecting rod comprising:
a shank including
a piston pin end defining a complete piston pin bearing;
first and second rod components fixedly coupled to the piston pin end; and
a first portion of a crank pin end fixedly coupled to the first and second rod components and defining a first segment of a crank pin bearing,
wherein the first and second rod components are spaced apart from one another so that a first aperture is defined between the rod components and between the piston pin bearing and the first segment of the crank pin bearing;
a cap that forms a second portion of the crank pin end and defines a second segment of the crank pin bearing; and
means for fastening the cap to the shank, wherein the cap is capable of being removed from and attached to the shank.

2. The connecting rod of claim 1,
wherein the first segment of the crank pin bearing defined by the first portion of the crank pin end includes approximately 180 degrees of the crank pin bearing, and
wherein the second segment of the crank pin bearing defined by the cap includes approximately 180 degrees of the crank pin bearing.

3. The connecting rod of claim 2, wherein the piston pin bearing has a piston pin axis and the crank pin bearing has a crank pin axis, wherein the piston pin and crank pin axes define a first plane, and wherein the cap interfaces the shank along a second plane that is perpendicular to the first plane along the crank pin axis.

4. The connecting rod of claim 2, wherein the crank pin bearing has a crank pin axis and wherein the cap is split from the shank along a first plane that includes the crank pin axis, wherein the first plane is non-perpendicular with respect to a second plane defined by the crank pin axis and a piston pin axis of the piston pin bearing.

5. The connecting rod of claim 1,
wherein the first segment of the crank pin bearing defined by the first portion of the crank pin end includes at least one of more than 180 degrees of the crank pin bearing and less than 180 degrees of the crank pin bearing, and
wherein the second segment of the crank pin bearing defined by the cap completes the crank pin bearing.

6. The connecting rod of claim 1, further comprising a pair of cylindrical sleeves, and
wherein the cap includes first and second holes on opposite sides of the second segment of the crank pin bearing and the first portion of the crank pin end includes first and second recesses on opposite sides of the first segment of the crank pin bearing, wherein the holes and recesses are positioned so that the first hole and first recess are aligned with one another and the second hole and second recess are aligned with one another when the cap and shank are assembled, and
wherein the cylindrical sleeves fit within the respective holes and recesses and align the cap with the shank.

7. The connecting rod of claim 6, wherein the means for fastening includes a pair of bolts,
wherein each of the bolts fits into a respective one of the cylindrical sleeves, and wherein the bolts allow the cap to be attached to the shank.

8. The connecting rod of claim 7, wherein each of the bolts has a head at a respective first end of the respective bolt, wherein the head is positioned alongside of the cap upon assembly of the connecting rod, wherein each head has a first outer diameter that is greater than a second outer diameter of its respective cylindrical sleeve, and wherein a second end of each respective bolt is at least one of coupled by threads with a respective additional hole within the first portion of the crank pin end, and coupled to a respective nut.

9. The connecting rod of claim 1,
wherein the shank is able to bear significant compressive stress applied proximate the piston pin bearing due to the first aperture between the first and second rod components.

10. The connecting rod of claim 1, wherein the cap and shank are manufactured by way of at least one of an extrusion process and a powdered-metal process.

11. A connecting rod comprising:
a first side component including
a first portion of a piston pin end defining a first segment of a piston pin bearing;
a first portion of a crank pin end defining a first segment of a crank pin bearing; and
a first rod component fixedly coupled between the first portions of the piston pin end and crank pin end, respectively;
wherein the first side component is configured to be assembled together with a second side component having a second rod component, and
wherein the first side component is configured so that upon assembly with the second side component, a first aperture is formed between the first and second rod components.

12. The connecting rod of claim 11, further comprising the second side component, wherein the second side component includes
a second portion of the piston pin end defining a second segment of the piston pin bearing;
a second portion of the crank pin end defining a second segment of the crank pin bearing; and
a second rod component coupled between the second portions of the piston pin end and crank pin end, respectively, wherein the first aperture is formed between the first and second rod components.

13. The connecting rod of claim 12, wherein the first and second side components are identical, and interface one another along a plane defined by axes of the piston pin bearing and the crank pin bearing when the connecting rod is assembled.

14. The connecting rod of claim 13, wherein each of the first and second side components can be manufactured successively as part of a manufacturing process by which a plurality of the side components are manufactured, and wherein the first and second side components are capable of being clamped around at least one of a piston pin and a crank pin to prevent relative movement between the side components and the at least one pin.

15. The connecting rod of claim 12, further comprising a pair of cylindrical sleeves,
wherein the first side component includes first and second holes on opposite sides of the first aperture, and the second side component includes first and second recesses on opposite sides of the first aperture,
wherein the holes and recesses are positioned so that the first hole and first recess are aligned with one another and the second hole and second recess are aligned with one another when the first and second side components are assembled, and
wherein the cylindrical sleeves fit within the respective holes and recesses and align the first and second side components with one another.

16. The connecting rod of claim 15, further comprising a pair of bolts,
wherein each of the bolts fits into a respective one of the cylindrical sleeves, wherein the bolts allow the first side component to be attached to the second side component, and wherein the first and second cylindrical sleeves are respectively positioned between the first aperture and the crank pin bearing and the first aperture and the piston pin bearing, respectively.

17. The connecting rod of claim 16, wherein each of the bolts has a head at a respective first end of the respective bolt, wherein the head is positioned alongside of the first side component upon assembly of the connecting rod, wherein each head has a first outer diameter that is greater than a second outer diameter of its respective cylindrical sleeve, and wherein a second end of each respective bolt is at least one of coupled by threads with a respective additional hole within the second side component, and coupled to a respective nut.

18. The connecting rod of claim 12, wherein the first and second side components are manufactured by way of at least one of an extrusion process and a powdered-metal process.

19. A method of assembling a connecting rod comprising:
providing a first part of the connecting rod, wherein the first part includes first and second holes;
providing a second part of the connecting rod, wherein the second part includes third and fourth holes, and wherein the holes are positioned so that, upon assembling the first part with the second part, the first hole is aligned with the third hole and the second hole is aligned with the fourth hole;
inserting first and second cylindrical sleeves into one of the first and third holes and one of the second and fourth holes, respectively;
putting together the first and second parts of the connecting rod so that the first cylindrical sleeve extends into both the first and third holes and the second cylindrical sleeve extends into both the second and fourth holes, wherein the first and second cylindrical sleeves align the first and second parts; and
fastening the first and second parts together by way of first and second bolts that extend through the first and second cylindrical sleeves, respectively.

20. The method of claim 19, wherein the first part is at least one of a shank and a first side component, and the second part is at least one of a cap and a second side component, and wherein each bolt extends from a first side of the first part, through the respective cylindrical sleeve, and beyond the cylindrical sleeve, so that an end of the bolt is at least one of attached to a nut and attached to the second part.
